(19) United States
(12) Patent Application Publication
(10) Pub. No.: US 2014/0144386 A1
(43) Pub. Date: May 29, 2014

(54) SAVING DEVICE FOR BIRD HOUSES FEEDERS AND FEED

(71) Applicants: Daniel Scott Amundson, Winona, MN (US); James Joyce, Custer, SD (US); Scott Tarras, Rushford, MN (US)

(72) Inventors: Daniel Scott Amundson, Winona, MN (US); James Joyce, Custer, SD (US); Scott Tarras, Rushford, MN (US)

(21) Appl. No.: 14/092,510

(22) Filed: Nov. 27, 2013

Related U.S. Application Data
(60) Provisional application No. 61/731,271, filed on Nov. 29, 2012.

(51) Int. Cl. A01K 31/00; A01K 39/01

(52) U.S. Cl. CPC A01K 31/00; A01K 39/0113
USPC 119/428

(57) ABSTRACT

A saving device for bird houses, feeders and feed is provided that includes a vertical member secured in an anchor medium topped by a pulley supporting a line able to be fastened by a cleat. The line attached to a sleeve traveling up and down the vertical member, by the action of an operator, is fitted with hooks to support feeders and houses for target species, protected by a guard and hanger clamp assembly, a means to hinder non-target animals from accessing and destroying feeders and houses for target species.

### RELATED APPLICATION

This application claims the benefit of U.S. (Provisional) Application No. 61/731,271 filed on Nov. 29, 2012.

### BACKGROUND OF THE INVENTION

The present application relates to saving devices for bird houses, feeders and feed, in particular to saving devices for use in domestic and commercial situations, for example, devices to be used at homes, residences for the elderly or disabled, outside businesses, at refuges or any place where target species are fed.

Feeding targeted species such as birds is recreational, therapeutic and of ecological importance. Often time, targeted species, such as birds, go without food because of the invasion of non-target animals such as squirrels, deer and bear.

In addition to the lost feed eaten by unwanted critters, many bird houses and feeders are destroyed by non target species. For example; squirrels, deer, bear and other predators will chew through or tear apart feeders in an effort to access the food and invade houses to eat eggs or the young.

Various attempts have been made at producing feeders that will hinder non-target animals from accessing or destroying them. Most designs are not reasonably effective in keeping non-target animals out, primarily because they are designed and placed at a level to be accessed by a person needing to fill them. Thus, most feeder designs are also easily accessed by non-target animals.

Accordingly there is a need for a saving device for bird houses, feeders and feed which overcomes the limitations of feeders noted above.

### SUMMARY OF THE INVENTION

In one aspect, a device is provided that includes: a vertical member having a length between a bottom end and a top end opposite the bottom end; a carrier sleeve slidingly coupled to the vertical member such that the carrier is operable to slide along the length of the vertical member between at least a first position and a second position vertically lower than the first position, the carrier sleeve comprising a plurality of hooks extending outward from the carrier sleeve; and a guard coupled to the carrier sleeve vertically below the carrier sleeve that prevents non-targeted species from climbing vertically along the vertical member.

In one embodiment, the device includes a pulley attached to the top end of the vertical member and a line, the line coupled to the carrier sleeve and the pulley so as to allow the carrier sleeve's vertical position to be adjusted by pulling the line through the pulley.

In one embodiment, the device includes an anchor for securing the line to the vertical member and therewith the carrier sleeve in the first position.

In one embodiment, the carrier sleeve is a tubular section through which the vertical member passes.

In one embodiment, the guard is located vertically below the hooks.

In one embodiment, the vertical member has a circular cross section with a diameter of about 2 inches and wherein the guard has a circular opening therein through which the vertical member passes, the opening having a diameter less than about 2.5 inches.

In one embodiment, the guard has a diameter of at least 15 inches.

In one embodiment, the device includes a hanger clamp coupled to the carrier sleeve, wherein the guard is coupled to the carrier sleeve in a non-fixed arrangement via the hanger clamp.

In one embodiment, the hanger clamp comprises a plurality of contact points and wherein the guard rests on the plurality of contact points such that the weight of non-targeted species on the guard causes the guard to tip and the non-targeted species to fall off of the guard.

In one embodiment, the plurality of contact points each comprise a rod bent at an angle so as to terminate at an end that points vertically upward, protruding outward from the hanger clamp, and wherein the guard rests on the ends of the rods.

In one embodiment, the rod is bent at about a 90 degree angle.

In one embodiment, the rod end extends outward from the hanger carrier at least 1 inch.

In one embodiment, the plurality of rods are affixed in an equidistant fashion about the circumference of the hanger clamp.

In one embodiment, the hanger clamp is suspended from the carrier sleeve with a plurality of connecters.

In one embodiment, the carrier sleeve has a plurality of equidistant vertical notches within an inner surface of the carrier sleeve.

In one embodiment, each notch has a width of about 10.09 degrees of arc, a radius of about 0.18 inches and a length of about 7 inches.

Additional aspects of the present invention will be apparent in view of the description which follows. A saving device for bird houses, feeders and feed as described herewith.

### BRIEF DESCRIPTION OF THE FIGURES

FIG. 1 is a perspective view of the saving device for bird houses, feeders and feed, in use.

FIG. 2 is a front elevation view.

FIG. 3 is a back elevation view.

FIG. 4 is a right side elevation view.

FIG. 5 is a left side elevation view.

FIG. 6 is a top view.

FIG. 7 is a bottom view.

FIG. 8 is a top perspective view of the sleeve, hooks and guard.

FIG. 9 is a vertical center section view of the sleeve taken from FIG. 8.

FIG. 10 is a horizontal mid-section view of the sleeve taken from FIG. 8.

FIG. 11 is a bottom perspective view of the guard and hanger clamp.

FIG. 12 is a perspective view of another embodiment of the saving device for bird houses, feeders and feed, in use.

### DETAILED DESCRIPTION OF THE INVENTION

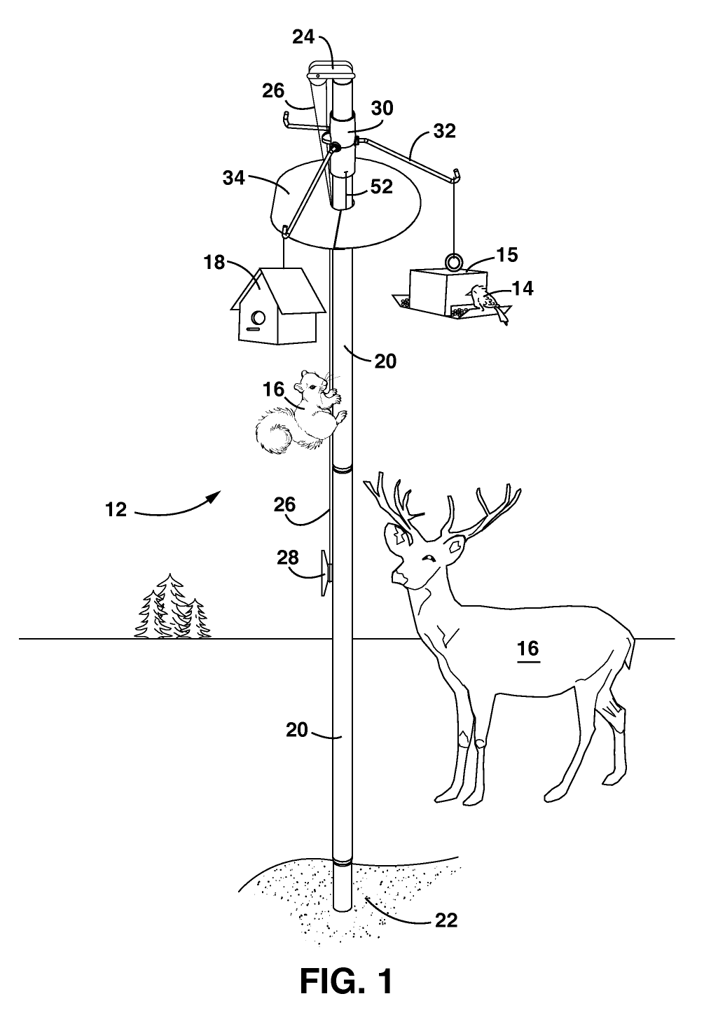

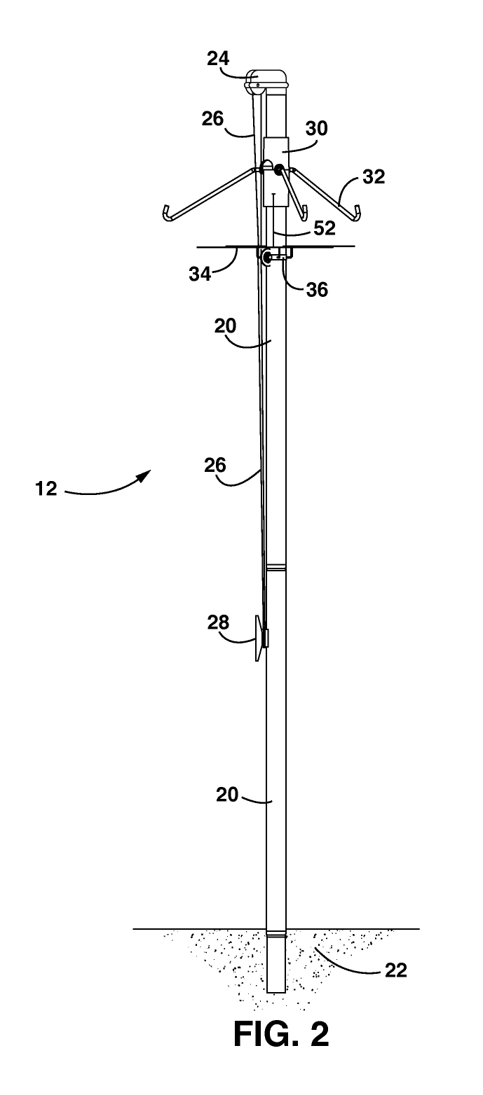

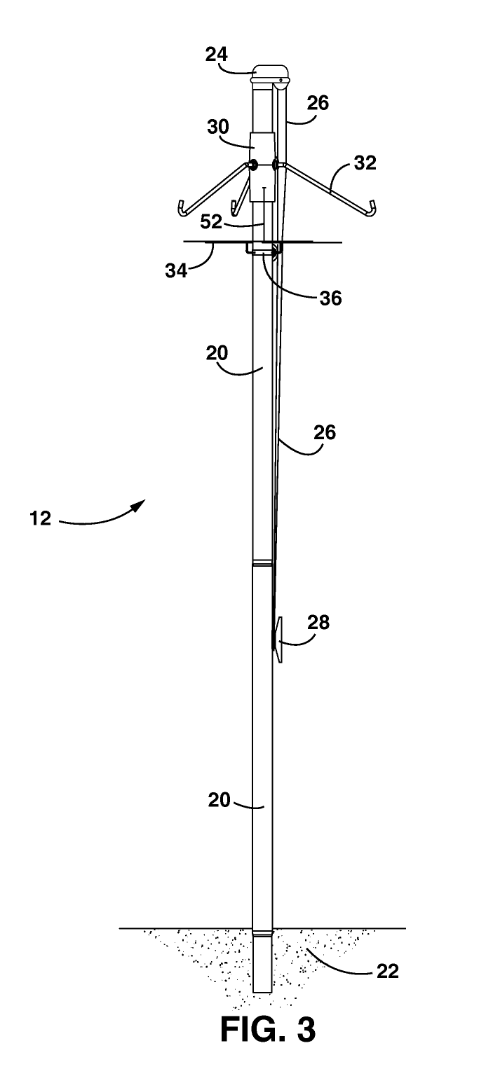

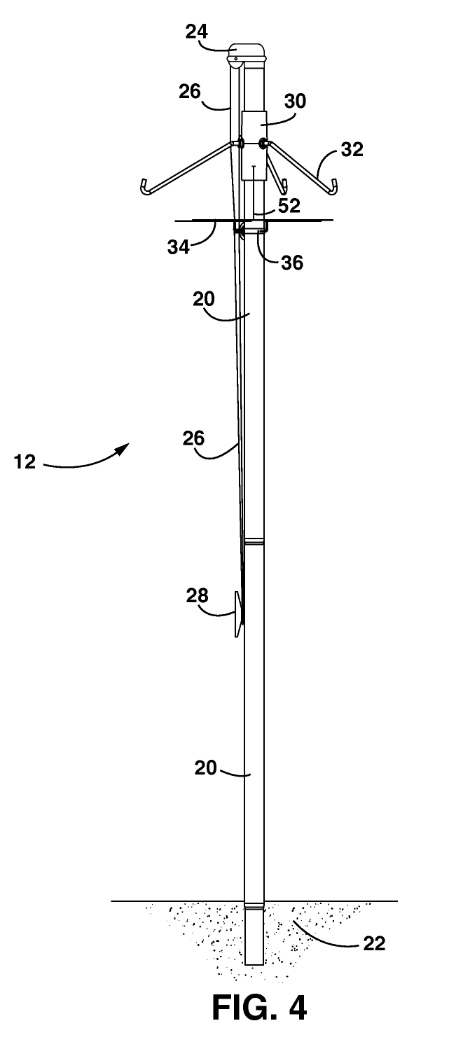

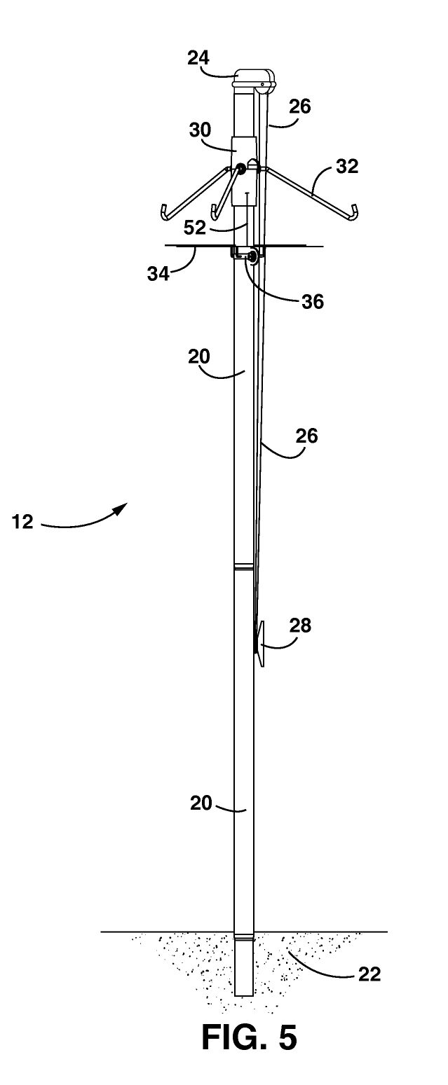

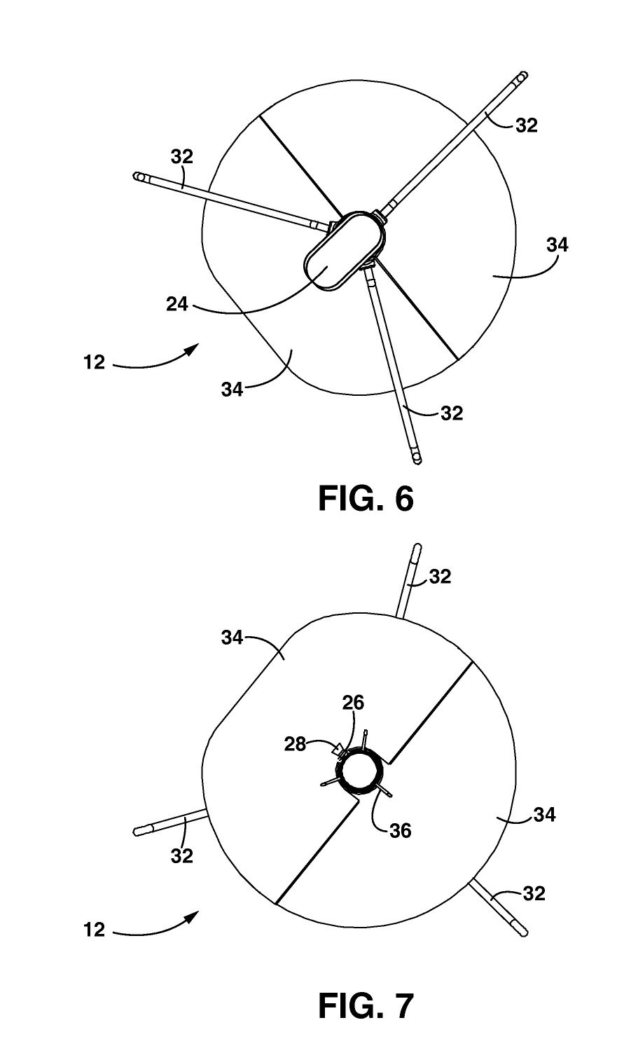

Referring to FIG. 1 through FIG. 7 of the feed saving device 12. The feed saving device 12 is a device designed to preserve feed for target species 14 and to prevent non-target species 16 from access to bird feeders 15 and houses 18 at the same time providing easy access to the operator for filling and maintenance. The feed saving device 12 consists of a vertical member 20 of sufficient height to keep bird feeders 15 and houses 18 out of the reach of non-target species 16 such as deer and bear. Feeders and houses 18 are suspended from the vertical member 20 by a sliding carrier sleeve 30 with hooks 32. The vertical member 20 passes through the middle of the sleeve 30 and the sleeve 30 is held in position by a line 26 such as a rope or cable so as to allow the carrier sleeve 30 to slide vertically along the vertical member 20 when the rope or cable is released. The hooks 32 are space equally and extend a sufficient distance from the vertical member 20 to provide space for multiple feeders 15 and houses 18. The sleeve 30 is designed to slide freely on the vertical member 20 despite largely variable sizes and weights of feeders 15 and houses 18. The sleeve's 30 vertical position can be adjusted by pulling the line 26 through a pulley 24 at the top of the vertical member 20. The line 26 is quickly and easily attached to the sleeve 30 through a connection means 40 mounted on the side of sleeve 30. Connection means 40 contains a slot 50. The connection means 40 is designed to prevent non-target species 16 from access to the attachment of the line 26 by a mass of material at the end of line 26. The sleeve 30 is held in position by securing the line 26 to the vertical member using a cleat 28 or other anchoring device.

The feed saver device 12 is a feed conservation device, containing a guard 34, and can be lowered for easy access to the feeders 15 and houses 18 by the operator. By doing so any individual, even individuals confined to a wheel chair can easily access anything attached to the sleeve 30 and hooks 32. In addition, the operator can elevate the feeders 15 and houses 18 above the reach of non-target species 18. So that target species 14 can feed from and use the elevated and guarded feeders 15 and houses 18.

The vertical member 20 can be made of one or more sections and is about 2 inches in diameter and about 9 foot in length, above an anchor medium 22. The anchor medium 22 can be material such as soil, concrete or rock. The anchor medium 22 can be below grade or above grade in a container. Vertical member 20 can be made of steel, aluminum, wood or any other material known in the arts. In one embodiment the cross section of vertical member 20 is circular. In other embodiments the cross section could be of any shape. The top end of vertical member 20 is fitted with a pulley 24. The pulley 24 contains at least one wheel that is able to support a line 26. The line 26 can be a rope, cord or wire that has a length sufficient to form a loop from the pulley 24 to a distance below the cleat 28. One end of the line 26 is affixed to the sleeve 30. The cleat 28 is affixed to the vertical member 20 about 4 feet above the anchor medium 22. The cleat can be made of steel, aluminum, wood or any other material known in the arts.

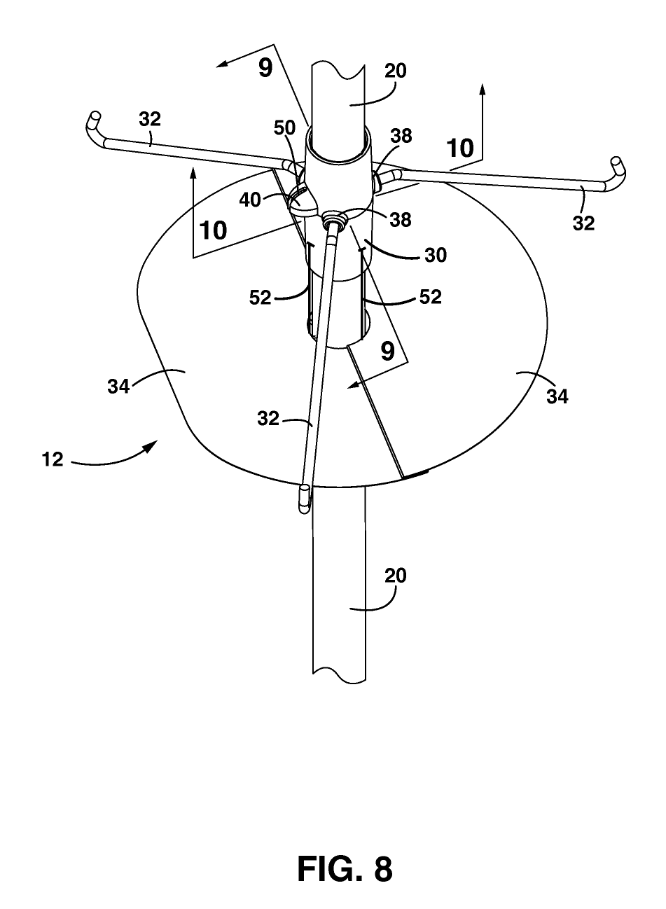

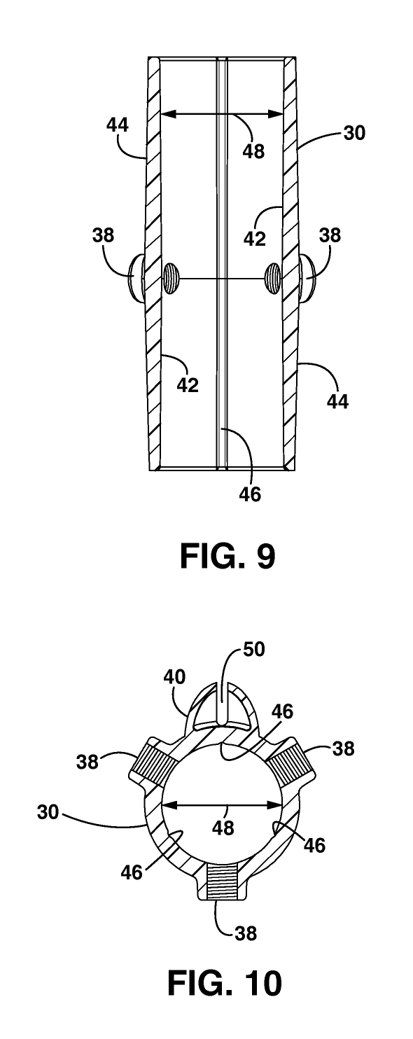

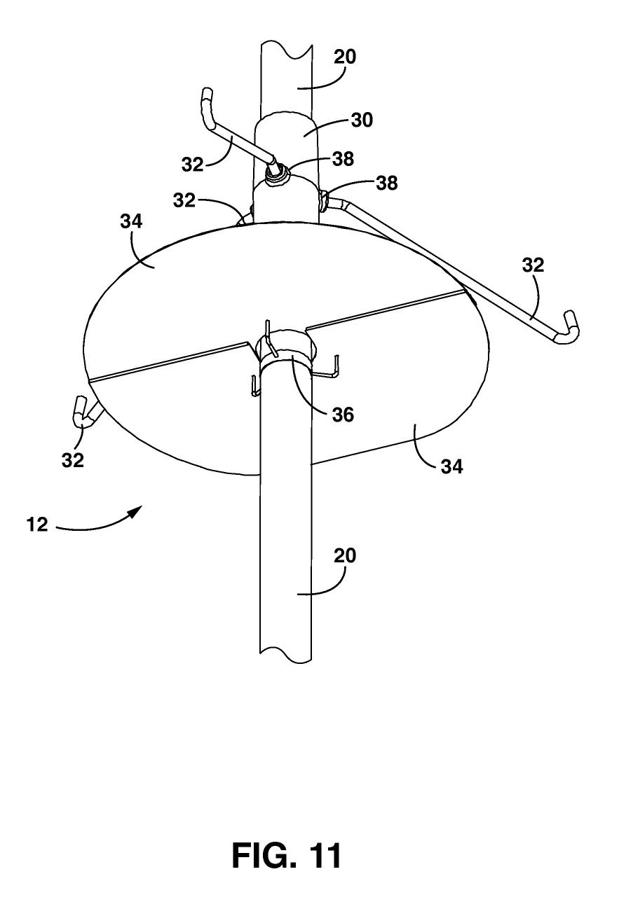

Referring in more detail to FIG. 8 and FIG. 11. The guard 34 is a shielding device that prevents non-target species 16 from accessing the feeders 15 and houses 18 by climbing the vertical member 20. The guard 34 is comprised of one or more pieces. In one embodiment the guard 34 is comprised of two pieces that connect in a central lap joint and can be made of steel, aluminum, plastic or any other ridged material. The guard 34 is about 0.024 inches thick and a minimum of about 15 inches, or greater, in diameter and contains a center hole of about 2.38 inches in diameter. The guard 34 is held in position by a hanger clamp 36 that has at least three contact points on the end of a vertical rod or wire over which the guard 34 rests. The connection between the three contact points and the guard 34 is not fixed. When a non-target species 16 contacts the guard 34 the non-target species body weight causes the guard 34 to tip and throw the non-target species 16 out of balance and causes non-target species 16 to fall to the ground.

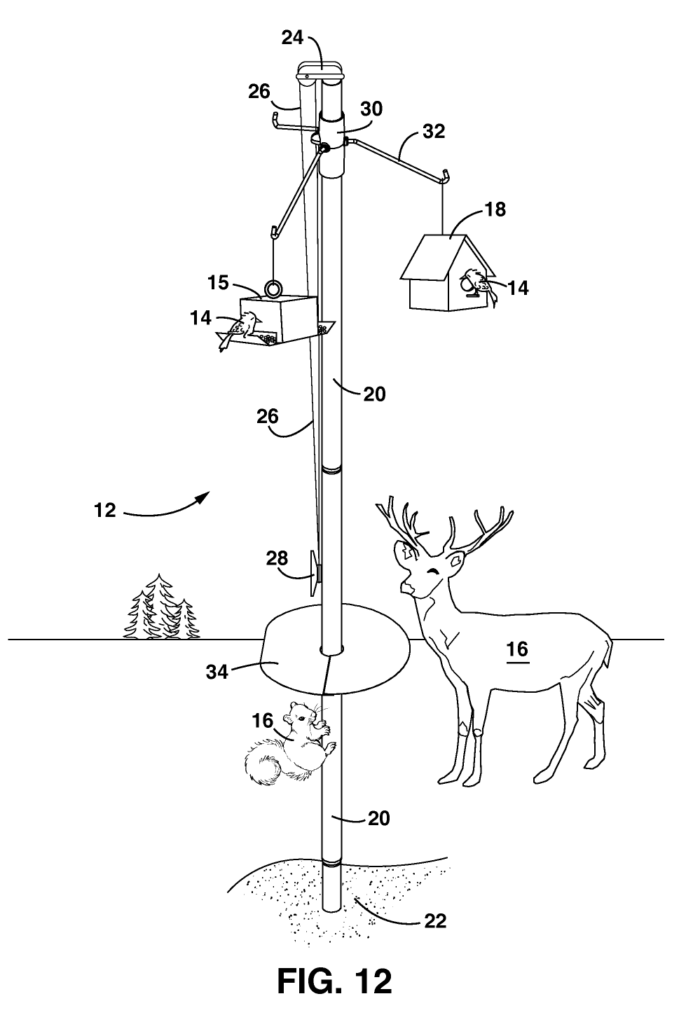

The hanger clamp 36 can be made from steel, aluminum, plastic or any other material well known in the arts. The hanger clamp 36 is made from a bar about 0.02 inches thick and about 0.5 inches wide. Hanger clamp 36 has at least three protruding rods about 0.13 inches in diameter bent into a 90 degree angle with a length of about 1.06 inches and a height of about 1.06 inches. The protruding rods are positioned and affixed in an equidistant fashion about the circumference of the bar so that one leg of the rods is horizontal and the other leg vertical. In one embodiment hanger clamp 36 has a diameter of about 2.38 inches and is suspended from sleeve 30 by at least three connectors 52 and moves in accord with sleeve 30 as it is raised and lowered by an operator. Hanger clamp 36 has a set of tabs about 0.43 in length, at its ends, that contain a hole for fixing the tabs together by a fastener to form a circle. Referring to FIG. 12. In another embodiment hanger clamp 36 has a diameter of about 2.04 inches and is affixed to vertical member 20 in a permanent location below cleat 28.

The sleeve 30 can be made from plastic or any other material well known in the arts. The sleeve 30 is about 7 inches in length and has an outside diameter of about 2.63. The outside diameter is measured along outside wall 44 about 3.75 inches from sleeve's 30 bottom edge or about 3.25 inches from sleeve's 30 top edge. Sleeve 30 has an outside diameter of about 2.45 inches at each end. The inside diameter 48 of sleeve 30 is about 2.04 inches and is cylindrical from top to bottom along inside wall 42, in one embodiment. In another embodiment there can be one or more notches 46 placed vertically about the inside diameter 48 in an equidistant fashion. In one embodiment there are three notches 46. The width of the notches 46 is about 10.09 degrees of arc, the radius of the notch 46 is about 0.18 inches and its length is about 7 inches. The purpose of the notches 46 is to reduce points of friction between sleeve 30 and vertical member 20. The purpose of the notches 46 is also to facilitate the exodus of moisture to prevent build up of moisture between the sleeve 30 and vertical member 20 in cold temperatures. Should trapped moisture freeze the sleeve 30 may become frozen to the vertical member 20 and not slide properly. In other embodiments notches 46 could be of other sizes and dimensions. Sleeve 30 has one or more protrusions 38 placed about its largest outside diameter. The protrusions 38 have a cylindrical inside diameter with about a ⅜-16 machine thread that serves as a point of connection for hooks 32. The connection means 40 is attached to the outside wall 44 about at the largest point of outside diameter and is shaped as an enclosed arc with an open bottom. A slot 50 is contained within the top of connection means 40 and serves as an anchor point for the end of line 26 tied in a knot or fitted with a mass of extra material.

Hooks 32 can be made from steel, aluminum, plastic or any other material well know in the arts. In one embodiment hook 32 is made of about a 0.38 inch rod and measures about 14 inches over all in length. The end of the hook 32 that mounts into protrusion 38 is about 1.22 inches in length, is horizontal to the ground and has a machine thread about ⅜-16 in size. The rod, at this point, is bent down at about 150 degrees and extends a length of about 9.78 inches before it is formed to about a 0.69 upward radius at its outward end to form a secure point to hang feeders 15 and houses 18.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A device comprising:
a vertical member having a length between a bottom end and a top end opposite the bottom end;
a carrier sleeve slidingly coupled to the vertical member such that the carrier is operable to slide along the length of the vertical member between at least a first position and a second position vertically lower than the first position, the carrier sleeve comprising a plurality of hooks extending outward from the carrier sleeve; and
a guard coupled to the carrier sleeve vertically below the carrier sleeve that prevents non-targeted species from climbing vertically along the vertical member.

2. The device of claim 1, comprising a pulley attached to the top end of the vertical member and a line, the line coupled to the carrier sleeve and the pulley so as to allow the carrier sleeve's vertical position to be adjusted by pulling the line through the pulley.

3. The device of claim 2, comprising an anchor for securing the line to the vertical member and therewith the carrier sleeve in the first position.

4. The device of claim 1, wherein the carrier sleeve is a tubular section through which the vertical member passes.

5. The device of claim 1, wherein the guard is located vertically below the hooks.

6. The device of claim 1, wherein the vertical member has a circular cross section with a diameter of about 2 inches and wherein the guard has a circular opening therein through which the vertical member passes, the opening having a diameter less than about 2.5 inches.

7. The device of claim 6, wherein the guard has a diameter of at least 15 inches.

8. The device of claim 1, comprising a hanger clamp coupled to the carrier sleeve, wherein the guard is coupled to the carrier sleeve in a non-fixed arrangement via the hanger clamp.

9. The device of claim 8, wherein the hanger clamp comprises a plurality of contact points and wherein the guard rests on the plurality of contact points such that the weight of non-targeted species on the guard causes the guard to tip and the non-targeted species to fall off of the guard.

10. The device of claim 9, wherein the plurality of contact points each comprise a rod bent at an angle so as to terminate at an end that points vertically upward, protruding outward from the hanger clamp, and wherein the guard rests on the ends of the rods.

11. The device of claim 10, wherein the rod is bent at about a 90 degree angle.

12. The device of claim 10, wherein the rod end extends outward from the hanger carrier at least 1 inch.

13. The device of claim 10, wherein the plurality of rods are affixed in an equidistant fashion about the circumference of the hanger clamp.

14. The device of claim 8, wherein the hanger clamp is suspended from the carrier sleeve with a plurality of connecters.

15. The device of claim 1, wherein the carrier sleeve has a plurality of equidistant vertical notches within an inner surface of the carrier sleeve.

16. The device of claim 15, wherein each notch has a width of about 10.09 degrees of arc, a radius of about 0.18 inches and a length of about 7 inches.

17. A device comprising:
a vertical member having a length between a bottom end and a top end opposite the bottom end;
a carrier sleeve slidingly coupled to the vertical member such that the carrier is operable to slide along the length of the vertical member between at least a first position and a second position vertically lower than the first position, the carrier sleeve comprising a plurality of hooks extending outward from the carrier sleeve;
a pulley attached to the top end of the vertical member and a line, the line coupled to the carrier sleeve and the pulley so as to allow the carrier sleeve's vertical position to be adjusted by pulling the line through the pulley;
a guard coupled to the carrier sleeve vertically below the carrier sleeve that prevents non-targeted species from climbing vertically along the vertical member; and
a hanger clamp coupled to the carrier sleeve, wherein the guard is coupled to the carrier sleeve in a non-fixed arrangement via the hanger clamp.

18. The device of claim 17, wherein the vertical member has a circular cross section with a diameter of about 2 inches and wherein the guard has a circular opening therein through which the vertical member passes, the opening having a diameter less than about 2.5 inches.

19. The device of claim 18, wherein the guard has a diameter of at least 15 inches.

20. The device of claim 19, wherein the hanger clamp comprises a plurality of contact points and wherein the guard rests on the plurality of contact points such that the weight of non-targeted species on the guard causes the guard to tip and the non-targeted species to fall off of the guard, and wherein the plurality of contact points each comprise a rod bent at an angle so as to terminate at an end that points vertically upward, protruding outward from the hanger clamp, and wherein the guard rests on the ends of the rods.
